(19) United States
(12) Patent Application Publication
(10) Pub. No.: US 2016/0153522 A1
(43) Pub. Date: Jun. 2, 2016

(54) High Energy Density Composite Flywheels/Electromechanical Batteries

(71) Applicant: Management Services Group, Inc., Doing Business As (DBA) Global Technical Systems, Virginia Beach, VA (US)

(72) Inventors: Scott Eric Groves, Brentwood, CA (US); Stanley K. Ault, Cinebar, WA (US)

(73) Assignee: Management Services Group, Inc., Doing Business As (DBA) Global Technical Systems, Virginia Beach, VA (US)

(21) Appl. No.: 14/557,752

(22) Filed: Dec. 2, 2014

(51) Int. Cl. F16F 15/305

(52) U.S. Cl. CPC F16F 15/305

(57) ABSTRACT

This invention provides for a method to provide the highest possible stored energy density (Watt-hour/kg) in rotating composite flywheels, which in turn will enable an increased application of said devices. Segmented high density (mass loading) materials are positioned and bonded against all free inner surfaces of a high strength low density composite rotor/rim. Traditional composite flywheels do not incorporate mass loading of the composite rotor, i.e., most of the stored energy is contained in the rotating composite rotor. The segmented materials do not fail under the high centrifugal loads, thereby contributing significantly to the overall stored energy density of the composite flywheel system. The high strength composite rotor is engineered to withstand the additional centrifugal loading effects imparted from the segmented masses. An additional benefit from completely loading the inner surface of the composite rotor as uniformly as possible is that it minimizes any unwanted rotor dynamic instabilities.

### REFERENCES CITED

U.S. Patent Documents

| | | | |
|---|---|---|---|
| 3,602,066 | August 1971 | Weatherbee | 74/572.21 |
| 6,868,753 | March 2005 | Tsai | 74/572.21 |
| 5,760,506 | June 1998 | Ahlstrom | 310/74 |
| 4,285,251 | August 1981 | Swartout | 74/572.21 |
| 8,776,635 | July 2014 | Morgan | 74/572.21 |
| 7,267,028 | September 2007 | Gabrys | 74/572.11 |
| 6,995,529 | February 2006 | Sibley | 318/161 |
| 6,867,520 | March 2005 | Jennings | 310/90.6 |
| 6,688,191 | February 2004 | Canders | 74/572.11 |
| 6,247,382 | June 2001 | Umeki | 74/572.12 |
| 5,969,457 | October 1999 | Clifton | 310/216.002 |
| 5,778,735 | July 1998 | Groves | 74/572.12 |
| 5,758,549 | June 1998 | DeTeresa | 74/572.12 |
| 5,590,569 | January 1997 | Nardone | 74/572.12 |
| 4,765,198 | August 1988 | Stravrinidis | 74/572.11 |
| 3,683,216 | August 1972 | Post | 310/67R |
| 4,098,142 | July 1978 | Weyler | 74/572.12 |
| 5,614,777 | March 1997 | Bitterly | 310/74 |

### BACKGROUND OF INVENTION

Composite flywheels or electromechanical, batteries, as they are sometimes referred to, are part of a rapidly growing technology needed for cost effective, reliable, and robust energy storage.

This storage capability is needed to improve the economic performance and stability of our utility, industrial, and military grid infrastructures. Having higher energy storage density (Watt-hour/kg) enables a broader application suite of this technology.

Their uniqueness relative to most other portable storage technologies is that they are completely mechanical—storing their energy via rotational kinetic energy and delivering their energy back to the grid or local energized component via a motor/generator system integrally designed within the composite flywheel. Most other portable storage systems rely on some form of chemistry to store and deliver electrical energy.

Until now, rotating composite flywheel storage systems have lacked the necessary energy density (greater than 20 watt-hours/kilo gram) to penetrate the utility, industrial, and military storage markets. Typical energy densities have been similar to lead acid battery technology if not less. Our new technology offers the potential to exceed the energy density of advanced lithium ion battery technology which will be revolutionary.

Recent flywheels have been designed using advanced composite materials, new high strength steels, and combinations of both. Steel alone does not lend itself to having high energy density but is used sometimes because it is cheaper than advanced composite materials. Advanced composite materials alone result in higher energy storage over steel. High strength composite materials include but are not limited to carbon fibers, Kevlar fibers, and glass fibers. Neither combination approaches the stored energy densities relative to what we are proposing.

Eighteen general flywheel patents where sited from over 108 flywheel related patents researched—none of which had efforts to maximize the energy density of rotating flywheel storage systems like we have developed herein.

### SUMMARY OF INVENTION

It is the objective of the current invention to provide the highest stored energy density in rotating composite flywheels by incorporating segmented high density materials in direct conjunction with the inside face of the spinning advanced composite rotor. See FIG. 1. The stored rotational energy for a given system is represented by

$$E = \frac{1}{2} l {w}^{2}$$

The bigger the, I (mass moment of inertia of all rotating parts) and the faster one spins, w the more energy is stored. However all materials fail when driven too fast. The key is to balance how the mass moment of inertia is distributed. The mass moment of inertia for each individual component that is rotating is represented by

$$I = \frac{1}{2} m ( {r}_{o}^{2} + {r}_{i}^{2} )$$

Where m is the rotating mass and rₒ and rᵢ are the outer and inner radius of the locations of each individual mass component. This equation reveals why the farther out a rotating mass is for a given rotational speed, the larger the mass moment of inertia and therefore the higher the stored rotational energy. However, the centrifugal stresses that develop in a rotating system are also proportional to the square of the radius as well as the density of the material. The higher the density the faster the failure stresses build within a given monolithic (non-segmented) material. This is why light weight/low density advanced composite materials are superior to metals. This is also why segmenting the high density materials used in our new invention is so critical to high energy storage densities. This method essentially eliminates the excessively high centrifugal stresses that develop in high density materials like steel, which would otherwise fail under their own rotational forces.

Segmenting the high density mass loading materials is preferred over using monolithic versions of the material because the monolithic material will fail under the high rpm's necessary to achieve high energy storage density (energy density greater than 20 watt-hours/kilo gram).

Segmenting the high density materials results in essentially a localized pressure load that is transmitted to the inner surface of the composite rotor. The individual segmented materials can be scaled in size depending of the overall size requirements of the flywheel system, see FIG. 2. The high density segmented materials can either be inert or magnetic depending on application. The inert materials include but are not limited to steel and metal powder loaded polymers.

The advanced composite rotor is designed to robustly withstand this applied pressure load from the segmented mass as well as its own centrifugal stresses.

A unique stress state results from this that is very beneficial to the advanced composite rotors. Without the additional loading from the segmented high density masses the advanced-composite rotor always experience unwanted through thickness tensile stresses which ultimately prove fatal to the composite rotor. Many attempts and some patents have attempted to address this issue by constructing very thin press-fit composite or steels rings (shells) together to reduce this unwanted through thickness tensile stress loading pre-loading the through thickness (radial) direction with compressive forces. The radial acceleration from spin imparted to the segmented masses creates an effective localized compressive force/pressure to the inner surface of the composite rotor which results in a completely compressive through thickness stress state in our composite rotor. This is the desirable condition needed for higher energy storage from our composite flywheel system.

The segmented materials can either be inert or magnetic. When magnetic they can either be part of the motor generator system or part of the magnetic levitation system. One of the principal keys to our new invention is to completely cover every free surface of the inner composite rotor face. By doing so maximizes the available stored energy density with the composite flywheel system. High density mass loading materials include but are not limited to steel, metal powder loaded polymers, as well as magnetic materials.

An additional benefit from completely loading the inner surface of the composite rotor as uniformly as possible is that it minimizes any unwanted rotor dynamic instabilities. This is critical for long term reliability of the composite flywheel rotor.

### BRIEF DESCRIPTION OF THE DRAWINGS/FIGURES

FIG. 1. Two-dimensional view of segmented mass loaded composite flywheel rotor compared to a monolithic mass loaded composite flywheel rotor.

FIG. 2. Individual mass segment.

FIG. 3. Generic composite flywheel.

FIG. 4. Generic composite flywheel with segmented mass loading layers.

FIG. 5. Segmented high density mass loading assembly ring.

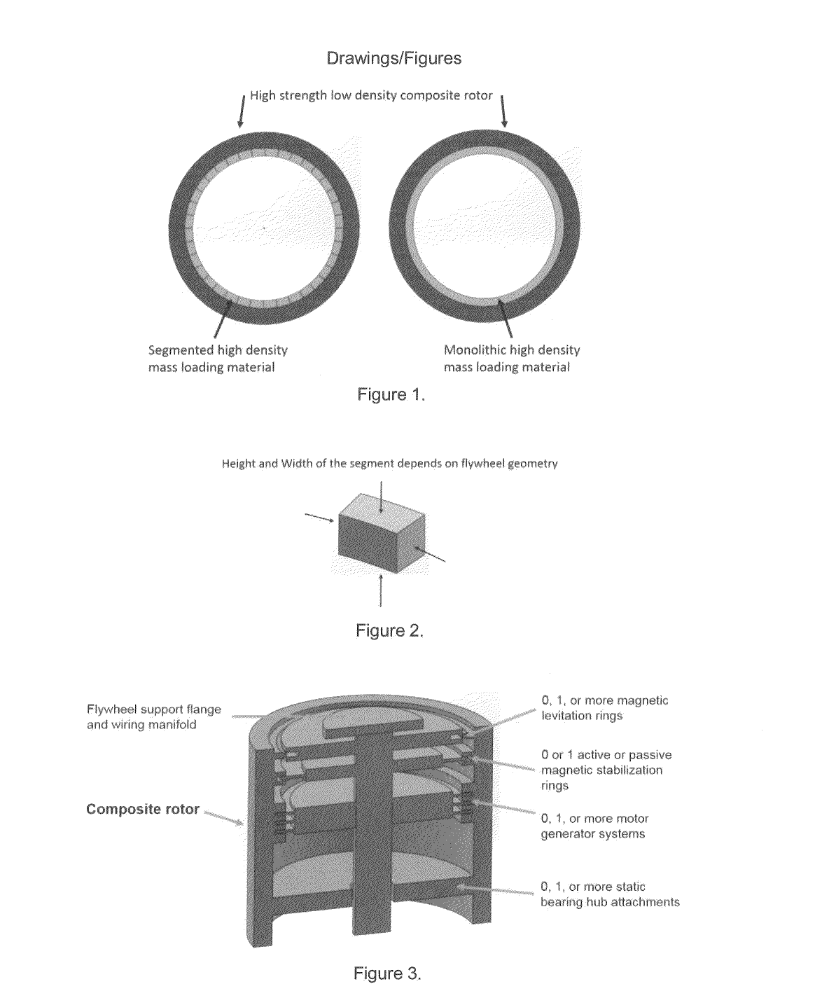

### DETAILED DESCRIPTION OF THE INVENTION

The general description of our high energy density flywheel is shown in FIG. 3.

All flywheel storage systems consist of a rotating mass or masses, hub attachment (connects the primary rotating mass to a stationary axial), bearings, and in most cases a motor/generator system. In our case the primary rotating mass is called the composite rotor. Some flywheel designs have the composite rotor completely separate from the motor generator and some have the motor generator in conjunction with the composite rotor as is shown with our general design in FIG. 3. The bearings can include but are not limited to magnetic levitation, active and passive magnetic stabilization, conventional mechanical bearings, or hybrid mechanical/magnetic bearing system.

Our method to increase stored energy density works with both approaches and independent of size of energy storage system. Adjustments to existing systems would be necessary to the design and rotational speed of the composite rotor. Specific patents (U.S. Pat. Nos. 5,778,735 and 5,758,549) have been co-developed in the past by this author that addresses how to handle the additional loading imposed on the composite rotor to ensure survivability. In addition to the effective pressure load induced on the inner face of the composite rotor, the segmented masses induce a localized shear forced on the inner face of the composite rotor that must be accounted for in the design of the inner face layer to the composite rotor. This method is fully described in the two specific patents (U.S. Pat. Nos. 5,778,735 and 5,758,549).

### How Increased Energy Storage is Achieved:

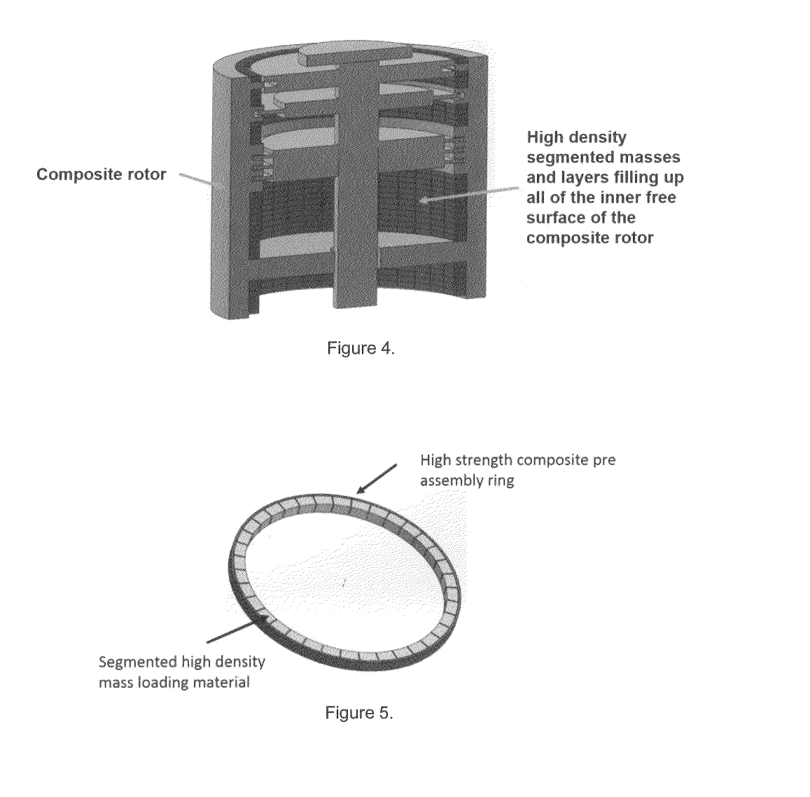

Segmented high density (mass loading) materials are positioned and bonded against all free inner surfaces of a high strength low density composite rotor/rim. The farther out the segments are, the higher the energy density. See FIG. 4. However, the farther out in radius that you go, a thicker/stronger composite rotor is required, in order to insure survivability at the high rotation rates needed to achieve high energy storage density.

It is not essential to cover the entire inner free surface of the composite rotor; however, it is required for maximum energy storage.

The segmented mass(es) are not randomly chosen. They are matched to have the same overall mass loading on the composite rotor as the motor generator layers and or magnetic levitation bearings impose on the inner surface of the composite rotor.

For manufacturability the segmented layers can either be pre-boned in individual thin composite rings, see FIG. 5, or grouped together in larger rings depending on the volume constraints for a given flywheel storage design. If the segments were part of the motor generator or magnetic levitation system then the appropriate orientation field of the magnets would be maintained. The individual rings or groups of rings are then appropriately assembled inside the primary composite rotor.

### How Improved Rotor Dynamic Stability is Achieved:

When a typical flywheel rotor system spins faster or slower during a charging or discharging event, the dynamic loading across the inner surface of the composite rotor is very non-uniform. This can produce significant rotor dynamic instabilities which can limit the ability of the flywheel to charge or discharge rapidly.

Dynamic rotor stability is achieved by completely loading the inner surface of the composite rotor as uniformly as possible. Essentially this is the same process for creating higher stored energy density. This is critical for long term reliability of the composite flywheel rotor.

The invention claimed is:

1) Higher stored energy density (Watt-hours/kg) in rotating composite flywheels/electromechanical batteries.

2) Because of how claim 1 is designed it results in a better rotor dynamic stability as the flywheel is charged and discharged throughout it life expectancy.

3) Because of claim 2 faster charging and discharging times are possible.

4) Because of how claim 1 is designed it results in a more uniform stress distribution along the inner face of the composite rotor which will improve the overall durability/life expectancy of the composite rotor.
